(19) United States
(12) Patent Application Publication
(10) Pub. No.: US 2010/0117840 A1
(43) Pub. Date: May 13, 2010

(54) FIRE ALARM AND LIKE DEVICES

(75) Inventors: Nicholas Alexander Rutter, Coventry (GB); Stuart Arthur Hart, Coventry (GB)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: FIREANGEL LIMITED, Coventry (GB)

(21) Appl. No.: 12/595,508

(22) PCT Filed: Apr. 11, 2008
(86) PCT No.: PCT/GB2008/001293

§ 371 Date: Oct. 10, 2009

(30) Foreign Application Priority Data
Apr. 11, 2007 (GB) 0706941.2

(51) Int. Cl. G08B 17/12

(52) U.S. Cl. 340/600; 340/632; 340/628; 340/693.7

(57) ABSTRACT

An alarm for detecting radiation and/or pollutants such as smoke, carbon monoxide or the like has a housing, a mounting plate for mounting the housing to a flat surface, cooperating means on the housing and the mounting plate engageable to secure the housing to the mounting plate, and an alarm circuit including a detector for detecting the radiation and/or pollutants. The alarm also has a switch in the alarm circuit in the housing and a magnet on the mounting plate, the arrangement being such that the magnet actuates the switch in response to engagement of the housing with the mounting plate thereby to arm the circuit. A battery compartment in the housing receives a battery for the alarm and stop means prevent proper engagement of the cooperating means in the absence of the battery. The mounting plate is generally planar having an upper surface and a through-opening for receiving a fixing such as a screw for fixing the mounting plate to a generally flat surface. The through-opening is elongate having an enlarged portion for passage of the head of the fixing through the through-opening, a narrowed portion for retention of the head and a neck portion therebetween. The alarm circuit also preferably includes actuation means configured to scroll through the various functions of the alarm when the actuation means is activated in a particular fashion.

### BACKGROUND OF THE INVENTION

1. Field of the Invention

This invention relates to an alarm for detecting radiation, carbon monoxide, smoke and/or other air pollutants comprising particularly for use in a household environment.

2. Description of the Prior Art and Related Information

A typical conventional alarm is battery-powered and is intended to be fitted directly to a flat surface, such as a ceiling, by means of screws or the like which pass through the housing of the alarm. The alarm is usually provided with a removable cover, or a cover that pivots away to the side so that access can be gained to the housing interior to change the battery. The battery is commonly mounted by simply clipping onto a terminal pad.

Therefore the user can close the cover without a battery in place. In addition, because the battery is normally clipped onto a terminal holder it can easily be mounted in the wrong orientation. Both of these conditions provide a false sense of security to people seeing the alarm and believing it to be operational when in fact it is not.

In addition where the alarm is a multi functional device there are usually one or a number of buttons for the different functions and operations of the alarm and the user may have difficulty in operating the alarm. This problem is present when the alarm is new as few people tend to read instruction manuals. The problem is exacerbated when dealing with a second user of an alarm where it is likely that the manual has been misplaced or discarded. Consequently, if the alarm sounds and quick action is required, for example to silence the alarm, the possibility of the user removing or disabling the alarm, for example by removing the battery, are increased.

The above are some of the problems that can be encountered with these types of alarms and which have an effect on the usefulness of the alarms. These all relate to the action of the user or the ability of the user to bypass the operation of the device in a deceptive and potentially dangerous manner.

The present invention seeks to provide an improved alarm.

### SUMMARY OF THE INVENTION

According to an embodiment thereof, the present invention is an alarm for detecting radiation and/or pollutants such as smoke, carbon monoxide or the like. The alarm may include, for example, a housing, a mounting assembly configured to mount the housing to a flat surface; cooperating assemblies on the housing and on the mounting assembly, the cooperating assemblies being mutually engageable to secure the housing to the mounting assembly, an alarm circuit including a detector for detecting the radiation and/or pollutants, and a controller configured to control an arming of the alarm circuit, the controller comprising a switch assembly. The cooperating assemblies may be configured to actuate the switch assembly upon engagement of the housing with the mounting assembly to thereby cause the controller to arm the alarm circuit.

The switch assembly may include a magnetically operated switch and the cooperating assemblies comprise a magnet assembly. The magnet assembly may include a permanent magnet. The switch assembly may be configured to control a supply of power to the alarm circuit. The switch assembly may include a normally open switch in a power supply line for the alarm circuit.

According to another embodiment thereof, the present invention is an alarm for detecting radiation and/or pollutants such as smoke, carbon monoxide or the like. The alarm may include a housing, a mounting assembly configured to mount the housing to a flat surface, cooperating assemblies on the housing and on the mounting assembly, the cooperating assemblies being mutually engageable to secure the housing to the mounting assembly; a locator configured to house a battery for the alarm, and a stop assembly configured to prevent proper engagement of the cooperating assemblies in the absence of the battery in the battery housing.

According to further embodiments, the stop assembly may be configured to be biased towards a first, stop position that prevents proper mutual engagement of the cooperating assemblies in the absence of the battery in the locator and may be further configured to be displaced into a second, release position by correct insertion of the battery in the locator to thereby enable proper mutual engagement of the cooperating assemblies to secure the housing to the mounting assembly. The cooperating assemblies may be mutually engageable by rotation of the housing relative to the mounting assembly to secure the housing to the mounting assembly. The cooperating assemblies may include a retaining assembly on one of the housing and the mounting assembly and an engagement assembly on the other one of the housing and the mounting assembly. The retaining assembly may include at least one hook-like member and the engagement assembly may include a respective flange engageable under the hook-like member by rotation of the housing relative to the mounting assembly. A plurality of the cooperating assemblies may be angularly spaced about an axis of rotation of the housing and the mounting assembly. The retaining assembly may be provided on the housing and the engagement assembly may be provided on the mounting assembly. The locator may include a battery compartment and the stop assembly may include a battery sensing member on the mounting assembly extending over the battery compartment and downwardly towards the housing, and an abutment on the housing. In the absence of a battery in the battery compartment, the battery sensing member may abut the stop on relative rotation of the housing relative to the mounting assembly to prevent proper engagement of the cooperating assemblies and in the presence of a correctly inserted battery in the battery compartment, the battery sensing member may be biased away from the housing so as to clear the stop on relative rotation of the housing relative to the mounting assembly and allow proper engagement of the cooperating assemblies. The battery sensing member may include a tongue-like member.

An additional abutment may be provided that may be engageable with the battery sensing member on relative rotation of the housing and the mounting assembly to prevent proper engagement of the cooperating assemblies when the mounting assembly and the housing are incorrectly aligned. At least one of the abutment and the additional abutment may include an end wall of a recess in the surface of the housing. The recess may have a ramp-like base. The locator may include a battery compartment that may be configured to prevent incorrect insertion of the battery into the compartment. The battery may be of a type having positive and negative terminals of different sizes at one end, and the battery compartment may include electrical contacts at one end thereof for connection to the terminals of the battery, and the battery compartment may be configured, on the end wall, to prevent insertion of the battery with the terminals transposed. The battery compartment may be further configured to define a recess in the end wall for receiving a smaller one of the positive and negative battery terminals, the defined recess being too small to receive a larger one of the positive and negative battery terminals.

The advantage with this arrangement relates to the fact that the housing must be demounted from the mounting means to change the battery and cannot be remounted without a battery being in place. This prevents mounting of the device without a battery. Further, with this arrangement the battery may only be fitted when it is the correct battery and in the correct orientation so preventing incorrect mounting of a battery in the device that could lead to malfunctioning or damage to the device.

According to a still further embodiment, the present invention is an alarm for detecting radiation and/or pollutants such as smoke, carbon monoxide or the like, comprising a housing; mounting assembly for mounting the housing to a flat surface; cooperating assemblies on the housing and on the mounting assembly, the cooperating assemblies being mutually engageable to secure the housing to the mounting assembly, and an alarm circuit including a detector configured to detect the radiation and/or pollutants.

The mounting assembly may include a generally planar mounting plate having an upper surface and a through-opening for receiving a fixing such as a screw for fixing the mounting assembly to a generally flat surface, the through-opening being elongate and having an enlarged portion for passage of a head of the fixing through the through-opening, a narrowed portion for retention of the head and a neck portion therebetween. The neck portion may define a wall portion, the wall portion being formed by a tongue, the tongue being adapted to resile away from the opposing wall of the neck portion thereby to allow passage of the fixing from the enlarged portion to the narrowed portion, and to prevent passage of the fixing from the narrowed portion to the enlarged portion.

A still further embodiment of the present invention is an alarm for detecting radiation and/or pollutants such as smoke, carbon monoxide or the like comprising a housing; mounting assembly for mounting the housing to a flat surface; cooperating assemblies on the housing and on the mounting assembly, the cooperating assemblies being mutually engageable to secure the housing to the mounting assembly, and an alarm circuit, the alarm circuit including a detector configured to detect the radiation and/or pollutants. The alarm circuit may include an actuation assembly configured to scroll through various functions of the alarm when the actuation assembly is activated in a predetermined fashion.

The alarm circuit may include a microprocessor configured to control an operation of the alarm, the actuation assembly may include a switch in the alarm circuit, and the alarm circuit may be configured such that when the alarm is activated, actuation of the switch silences the alarm and configured such that, when the alarm is silent, actuation of the switch tests the alarm.

### BRIEF DESCRIPTION OF THE DRAWINGS

The invention will now be illustrated by way of description of an example of the present invention, with reference to the accompanying drawings, in which:

FIG. 1 shows a side view of an alarm in accordance with the present invention;

FIG. 2 shows a plan view of an upper housing member of the alarm shown in FIG. 1 with the battery omitted;

FIG. 2a shows a perspective view of the upper housing member from above;

FIG. 3 is a plan view of a mounting plate of the alarm of FIG. 1;

FIG. 4 is an inverse plan view of the mounting plate of the alarm of FIG. 1;

FIG. 5 is a circuit diagram of part of the circuitry of the alarm of FIG. 1;

FIG. 6 is an inverse plan view of the upper housing member with component parts attached; and

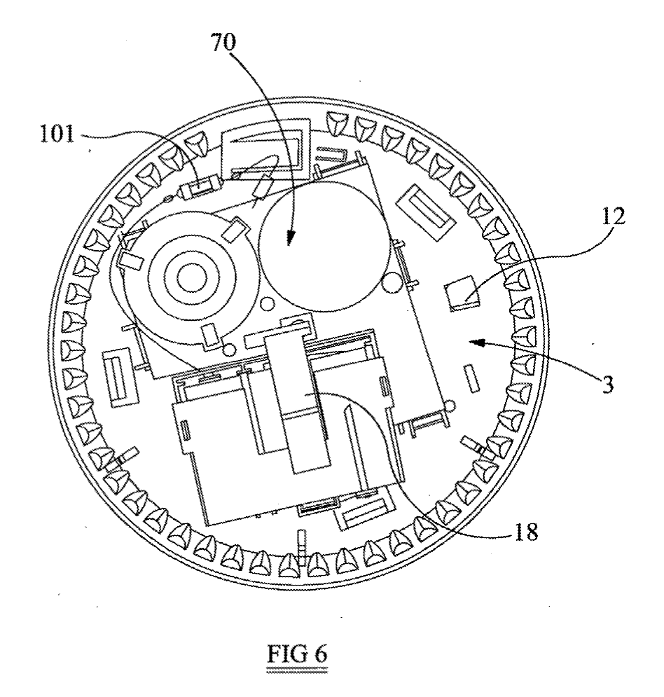

FIG. 7 is a view from below of a lower housing member of the alarm.

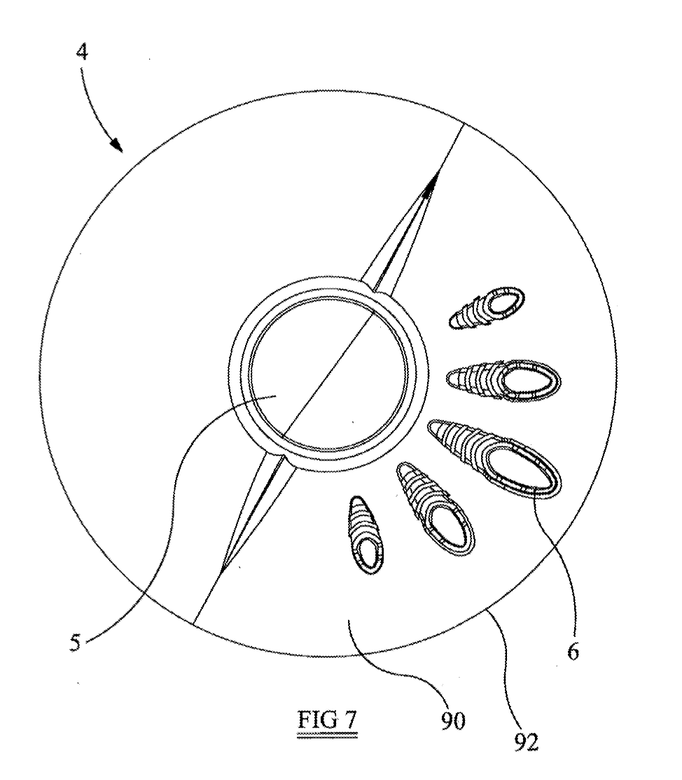

### DETAILED DESCRIPTION

Reference will now be made in detail to the construction and operation of preferred implementations of the present invention illustrated in the accompanying drawings. The following description of the preferred implementations of the present invention is only exemplary of the invention. The present invention is not limited to these implementations, but may be realized by other implementations. Indeed, In the below-described embodiment, the invention is described in relation to a smoke alarm. It will be appreciated, however, that the invention is equally applicable to an alarm for detecting other air pollutants and noxious and toxic gases such as carbon monoxide, radon or the like, or any forms of radiation.

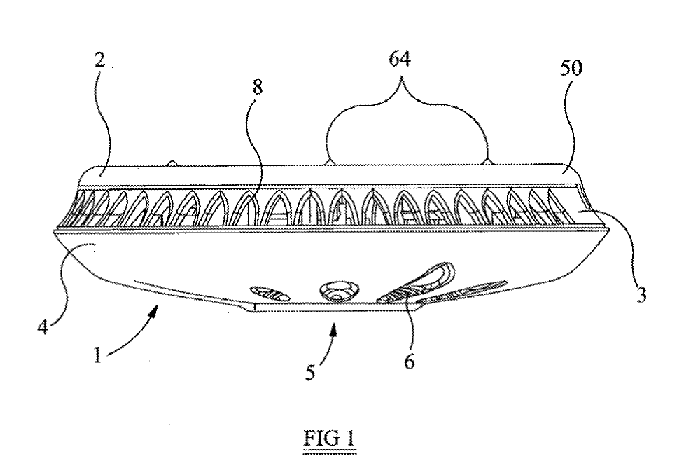

Referring to the drawings, FIG. 1 shows a side view of a preferred form of alarm 1 according to the invention. The alarm is suitable for mounting to a flat surface such as a wall or ceiling but is described here in relation to its mounting to a ceiling. Certain aspects of the present invention to be illustrated include design detail of the alarm and this will now be described in detail.

The alarm 1 comprises a housing and a mounting means for mounting the housing to the ceiling. The mounting means is in the form of a mounting plate 2 which is generally circular and planar. The housing has an upper housing portion or member 3, and a lower housing portion or member 4. The terms upper and lower are relative and depend on the orientation of the alarm but are used here in the sense that applies where the alarm is attached to a ceiling and as shown in FIG. 1.

The illustrated alarm is circular with a domed construction to give an aesthetically pleasing appearance.

The lower housing member 4 has a generally circular, domed construction with a substantially smooth outer surface 90 and rim 92. When the alarm is mounted to a flat surface this housing member 4 will be furthest from the flat surface. In the case of mounting to a ceiling, for example, the housing member 4 will face the floor. The member 4 includes, a “test function” and “silence” button 5 (the only button provided with this design of alarm) which is located at or near the apex of the dome. The housing member 4 also has a group of vents 6 (typically 5) in the surface of the dome just below the button 5. A speaker is mounted adjacent the vents 6 inside the housing of the alarm.

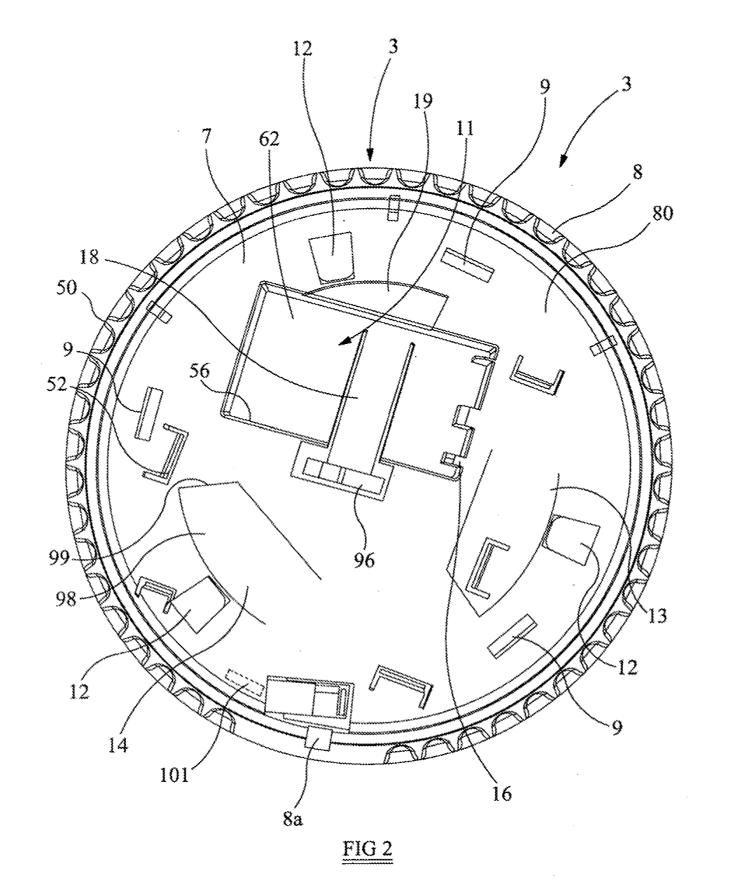

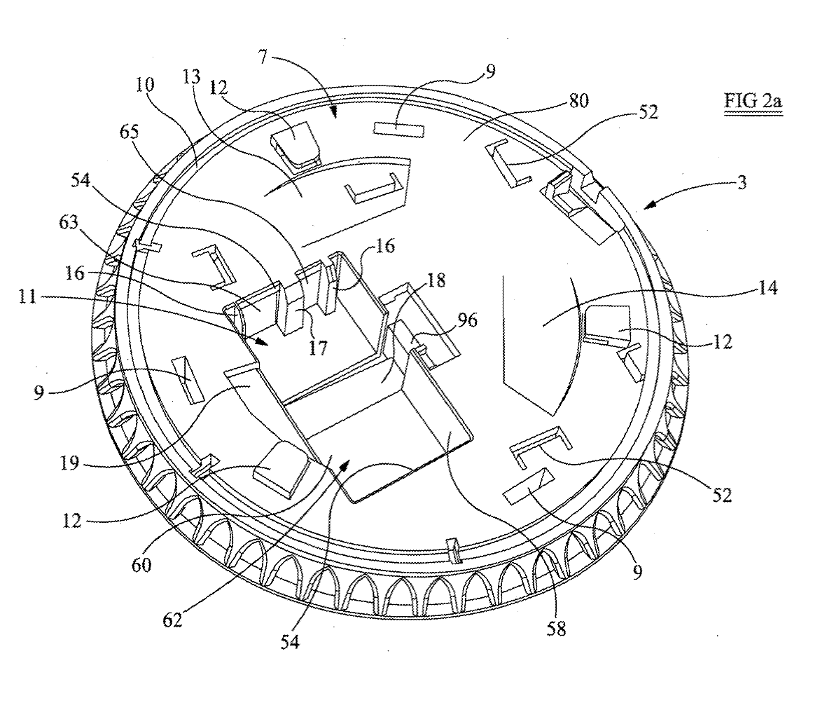

FIG. 2 is a plan view (i.e. from above) of the upper housing member 3. The upper housing member 3 is generally circular and includes a generally planar base in the form of a bottom or base plate 7 with an outwardly and downwardly angled sidewall 50 extending the full periphery. The sidewall 50 has a number of openings 8 spaced around the circumference of the base plate 7. These are preferably equi-angularly spaced along the sidewall 50 although any suitable spacing may be used. Alignment means in the form of a detent or slot 8a is provided in the sidewall 50 and its purpose is explained below. The openings 8 provide ventilation for the operating circuitry and also better enable the alarm to be heard when it is sounding.

The lower housing member 4 and upper housing member 3 are preferably snap-fitted together by catch means preferably in the form of cooperating lug and receptor assemblies 9. In this example there are three assemblies 9. The lugs are preferably formed on the lower housing member 4 and the receptors on the upper housing member 3 although it will be appreciated that these may be reversed. It will also be appreciated that more or fewer than three assemblies may be used and these are preferably equi-angularly spaced around the housing.

In this example of the present invention there are three lug and receptor assemblies 9 spaced apart in a particular orientation about the respective surfaces of the housing members 3 and 4 and the spacing of these arrangements is such that the two housing members will only snap together in one particular alignment. Each lug (not shown in the drawings) is upstanding on the inner surface of the lower housing member 4 and is formed with a hook-like end portion. This engages in a snap-fitting manner over a shoulder formed on the corresponding receptor. The latter is upstanding on the inner (lower) surface of the upper housing member 3.

When the housing members 3 and 4 are snapped together a space is defined therebetween in which the circuitry, speaker and other active components of the alarm can be housed. Suitable mounting means are provided for the mounting of these to the upper housing member 3 or the lower housing member 4.

The upper housing member 3, also includes the following:
a circumferential groove 10 at or adjacent the outer edge of the base plate 7. This is formed in the upper surface 80 of the base plate 7 as can be seen in FIG. 2a;
a battery locating means in the form of a battery compartment 11 which is formed as a well or recess in the upper surface of the base plate 7 and extends into the interior of the upper housing member 3;
retaining means 12 forming part of cooperating means for securing the upper and lower housing members together. Here, the retaining means 12 are in the preferred form of three hook-like members 12 equally spaced around the base plate 7. Although three members 12 are shown it will be appreciated that any suitable number may be used; and
a locking means 15 adjacent the outer periphery of the plate 7.

In the particular example shown in FIGS. 2 and 2a the battery compartment is sized and suited for the location and housing of a battery of the type having positive and negative terminals of different sizes at one end, such as a 9V PP3 battery. The battery compartment therefore comprises a generally rectangular well 62 having two end walls 54, two side walls 58 and a base 60. Means (not shown) are provided at one end for the location of terminals to connect the battery in the compartment 11 to the circuitry of the alarm.

Battery contact terminals of the alarm circuitry are located in designated terminal fixing points 63, 65 provided on the right hand end wall 54 of the well as seen in FIG. 2. The fixing points are defined by vertical side struts 16 disposed one adjacent each end of the end of the well and a centre strut 17 at a position offset from the centre of the respective end of the well. The struts 16 & 17 extend down the full depth of the well and project outwardly into the well to define recesses in the end wall 54. The terminals are located between the struts in the recesses so that the terminals are shielded from side access in the well 62. This means that the terminals will only be contacted when the correct battery is correctly inserted. The battery is fitted into the battery compartment from the outside of the upper housing member 3 i.e. from above as seen in FIG. 2. the spacing between one of the side struts 16 and the intermediate strut 17 is wide enough for the smaller of the two battery terminals but smaller than the larger battery terminal. This ensures that the battery cannot be incorrectly connected in the compartment 11.

As can be seen in FIGS. 2 and 2a the base 60 of the well 62 has a tongue 18 which is cut out of the base 60 and extends centrally across the width of the well 62. The tongue 18 is sprung slightly so that it extends out of the plane of the base 62 towards the lower housing member 4 and is generally L-shaped, having an arm 96 which extends upwardly. The tongue 18 is located above the button 5 so that as the button 5 is depressed the arm actuates a switch SW1 of the alarm circuit 70. The tongue 18 is preferably mechanically coupled to the button 5 although it can simply be in abutment.

The alarm has cooperating stop means on the upper housing member 4 and the mounting plate 2 which includes three arcuate indents or recesses 13, 14, 19 in the base plate 7. The arcuate indent 19 is provided in the base plate 7 adjacent one side wall 58 of the well 62 close to the edge of the plate 7. The first and second indents 13 and 14, and the indent 17 are equi-angularly spaced around the outer surface region of the base plate 7 of the upper housing member 3. The indents 13, 14 also have a ramp-like base 98 ending in a stop or wall 99.

The cooperating stop means on the mounting plate 2 is a battery sensing member in the preferred form of a cut-out tongue-like member 28 that is sprung out of the surface of the plate 2 towards the upper housing member 3. On the inner (lower) side of the tongue 28 there is a domed or raised portion 29. In its normal position the tongue 28 is orientated to protrude downwardly from the inner surface of the mounting plate 7 into the battery compartment 11.

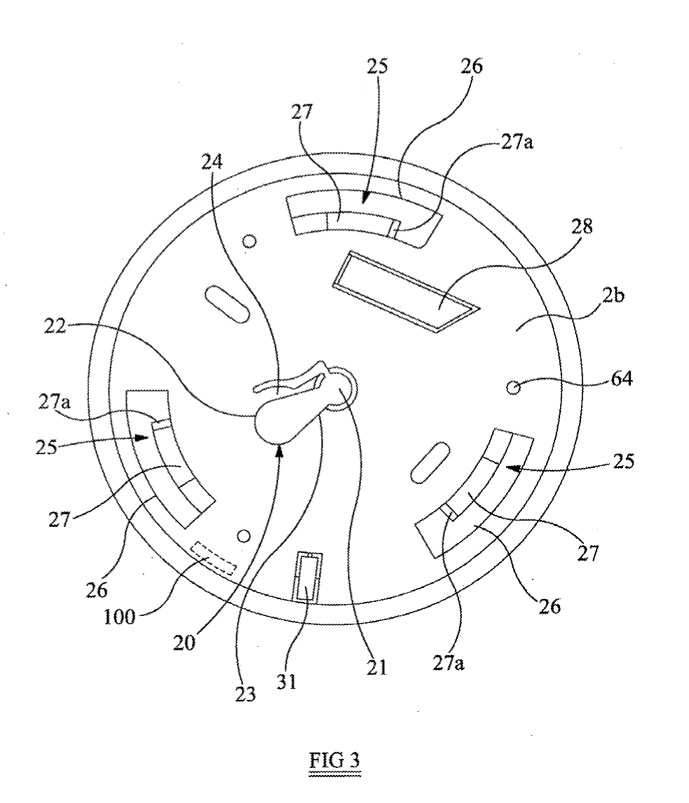

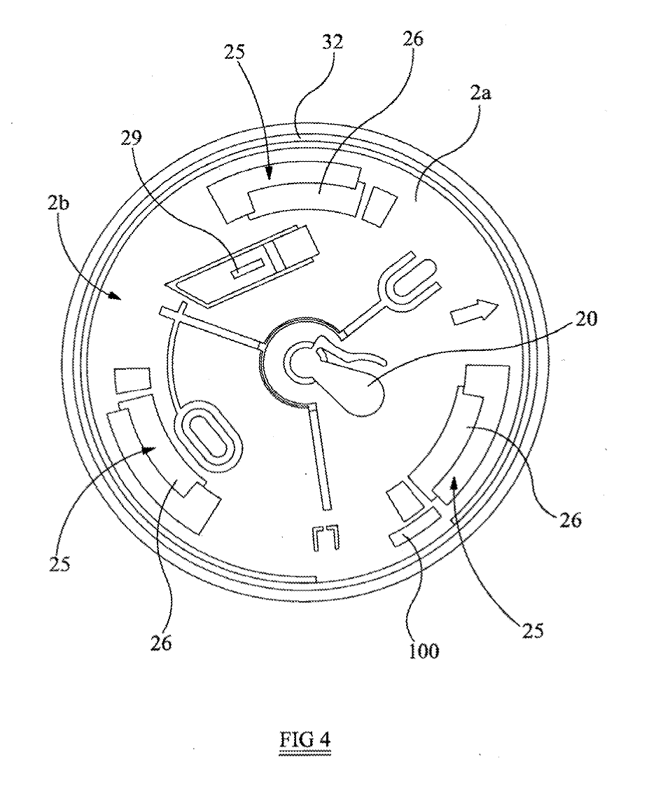

FIGS. 3 and 4 show the two sides of the mounting plate 2 which is suitable for mounting the alarm to a flat surface. FIG. 3 shows the external, upper surface 2a of the mounting plate which is in contact with the surface to which the alarm is mounted, and FIG. 4 shows the internal, lower surface 2b which faces the upper housing member 3. The mounting plate 2 comprises a substantially flat disc-shaped member of similar diameter to the diameter of the housing base plate 7.

The upper surface 2b is provided with three smooth surface mounting projections or nodules 64 that engage the ceiling and hold the major part of the surface of the mounting plate away from the ceiling surface.

The mounting plate 2 includes a centrally located fixing through-opening or hole 20 which enables the mounting plate 2 to be fixed to the ceiling by, for example, a dry wall fixing. This allows fixing in one operation and without drilling. This in turn means that the risk from asbestos, where present, is reduced or removed. The fixing hole 20 is keyhole shaped having a central, generally circular or narrowed portion 21 and a bulbous extension or enlarged portion 22 which forms a neck portion 23 where the bulbous extension 22 meets the central portion 21. A cut out sprung arm or tongue 24 is formed in one side wall of the bulbous portion 22. The tongue 24 forms a locating portion which resiles away from the fixing means when the latter is located in the bulbous section and slid up into the portion 21. Once the fixing means enters the central portion 21 the tongue 24 resiles back towards its original position, locking the fixing means securely in place in the central portion 21.

The mounting plate 2 also includes three engagement means 25. These engage with the retaining means 12 and thus form part of the cooperating means mentioned above for locking the mounting plate 2 to the upper housing member 3. The engagement means 25 are also equally spaced around the circumference of the mounting plate 2. Each engagement means 25 comprises an opening 26 of arcuate shape in the mounting plate 2 with a flange 27 formed on the lower surface 2a of the mounting plate 7. The flange 27 extends over part of the length of the opening from one end thereof and over part of the width. The flange 27 includes a chamfered end section 27a at its free end and a portion of reduced thickness at its other end.

A marker 31 is also provided in the mounting plate 2 adjacent the edge of the plate. This marker is conveniently a cut-out portion which is visible from the underside of the plate 2. A raised lip or ridge 32, conveniently extending along the periphery of the plate 2, is also provided on the lower surface 2a at or adjacent the edge of the mounting plate 2.

In use, the mounting plate 2 is first fitted to the ceiling, for example by means of a dry wall fixing. The fire alarm upper housing member 3 is then mounted to the mounting plate 2. In order to achieve this the marker 31 on the plate 2 is aligned with the detent 8a in the sidewall 50 of the upper housing member 3 but at a slightly offset angle (anti clockwise). This ensures that the upper housing member 3 fits against the mounting plate correctly and the raised lip 32 on the mounting plate 2 slots into the groove 10 of the upper housing member. In this position, the chamfered end section 27a of each flange 27 is aligned to one side of a respective hook-like member 12. If a battery is located in the battery compartment 11, when the upper housing member 3 is presented to the mounting plate 2 properly aligned, the tongue 28 is orientated to protrude downwardly from the inner surface of the mounting plate 7 into the battery compartment 11. The portion 29 of the tongue 28 thus engages the surface of the battery and the tongue 28 is upwardly displaced above the surface of the upper housing member 3.

As the fire alarm upper housing member is then rotated in a clockwise direction to locate the housing with respect to the mounting plate 2 each of the respective flanges 27 engages under the respective hook-like member 12 in a sliding action and, assuming certain other factors discussed below are met, the fire alarm can be rotated until the marker 31 is aligned with the detent 8a and the fire alarm is correctly mounted.

If there is no battery in the battery compartment 11 then the tongue 28 is not upwardly displaced as the fire alarm housing is presented to the mounting plate 2. The tongue 28, therefore, extends into the well 62 of the battery compartment. As the housing is rotated, the tongue 28 engages the end wall of the indent 19, preventing further rotation of the housing with respect to the mounting plate 2 and so preventing the alarm housing being secured to the mounting plate 2 and thus to the ceiling.

Furthermore, the particular design of alarm housing shown in the drawings has only three possible positions for mounting to the mounting plate 2. The correct position is as described above where the marker 31 is lined up relative to the detent 8a and the tongue 28 is engaged by the battery to allow fixing of the fire alarm to the mounting plate 2 and therefore the ceiling. In the event that an attempt is made to mount the device to the mounting plate 2 in either of the other possible positions (two with this example) the tongue 28 will locate in either the first or second indents 13, 14. Therefore as the alarm housing is rotated (no matter whether a battery is fitted or not) the tongue 28 will engage the end wall of the respective indent 13, 14 and again prevent securing of the alarm housing to the mounting plate and therefore the flat surface.

If an attempt is made to fit a battery incorrectly in the battery compartment 11, the battery will not sit fully in the compartment and will sit proud, thus preventing the upper housing member from being secured to the mounting plate 2.

The above describes an example of an alarm which includes safety features to ensure that the alarm may only be assembled when the correct battery is correctly fitted, and also to ensure that the battery is wired and connected correctly, so ensuring that when the alarm is fitted the alarm is operational (assuming that the battery carries a charge).

The following refers to a further preferred embodiment of alarm according to the invention. In this embodiment a magnet 100 is fitted into an indent provided in the lower surface 2a of the mounting plate 2. In the example shown this is located close to the marker 31.

In addition a hook means may be provided on the lower housing member 3 so that if the magnet is not present then the hook would locate in the indent provided in the mounting to prevent rotation of the housing on the mounting plate 2 and thus assembly of the alarm housing to the mounting plate 2. A reed switch 101 is located in the housing, on the lower housing member 3 in the vicinity of the indent 8a but on the inner (lower) surface.

The normal condition for the reed switch is open, preventing energizing of the alarm. When the alarm housing is properly fitted to the mounting plate 2, the reed switch 101 is located in the vicinity of the magnet. The magnetic field of the magnet moves the reed switch to the closed position, allowing power to be supplied to the alarm circuitry by the battery.

This means that the circuitry will only be armed when it has been fitted to the mounting plate. Therefore, unless the mounting plate is not itself fitted to a flat surface, this means that the alarm will only be active in situ.

The advantages with this arrangement result from the fact that the switch unit is a hermetically sealed unit and that with the mount and demount there is an automatic on/off switch. This second aspect of the invention may be use separately, or with either or both of the first and second aspects of the present invention.

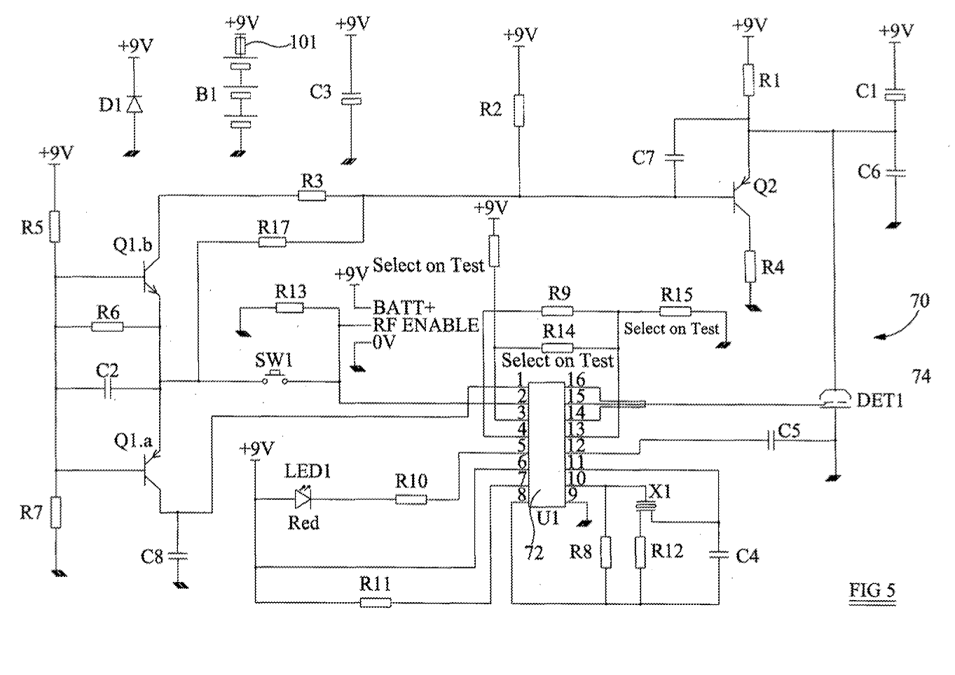

Turning now to the circuit of FIG. 5, alarms of various types are frequently used by persons without a useful knowledge of their operating principles. They consequently may not be capable of using the alarms correctly or in the best way. This is particularly true if an alarm has more than one function, which may be initiated by one or more user operated controls. Operation of multiple functions is frequently dependent on the user reading the instructions in a user manual and in practice this does not always happen. Even when the manual has been read thoroughly, the user may not remember the operating sequences when needed. The nature of an alarm is generally such that quick action is required, so there may not be sufficient time to re-read the manual or a quick operation is desired (to silence an alarm, for example). Commonly, the inability of the user to generate the required response from the alarm may result in its being removed and/or reported as being faulty, or the alarm disabled in some way (e.g. by removing a battery). The protection provided by the alarm is then removed.

A proposed solution to this problem is to minimize the number of user operated controls and to make their operation intuitive. Most users will normally only want and expect a limited number of reactions from their alarms. By minimizing the options available to the user and making the alarms react to simple operations, there is a greatly reduced dependency on learning written instructions. The likelihood of disabled alarms and reported nonexistent faults will consequently be much lower.

This principle can be applied to any number of functions on an alarm. In particular though, many alarms have only two main functions that a user will want to access; testing the alarm, and silencing the alarm. This applies generally to all alarm types.

Of the two functions described above, only one function will be required at any particular time, dependent on the operating state of the alarm. When the alarm is silent, the only function required will be “test”; when it is in alarm, the only function required will be “silence”. There is consequently no need to have more than one external control, as the switch function can be determined by the operating condition of the alarm.

This single control could take a number of different forms such as a switch, external light source (e.g. a torch), or any other method that can be user initiated.

In the above described embodiments the particular solution is to use a pushbutton switch on the alarm. Some existing alarms use a single pushbutton switch to control two functions, but these may operate both functions in sequence, depend on the switch being held for time periods specific to function, require the switch to be operated a certain number of times, or in some other way, require an action on the user that is not intuitive.

The proposed solution uses the alarm condition to determine how it will react to the operation of the switch. When the switch is operated, there is only one reaction required for the prevailing operating conditions. There is therefore no requirement for any complex analysis of the timing of the switch. It is either being pressed or it is not. The circuit could be designed, using electronics or software, to respond simply whenever the switch is operated for a minimum time (typically under a second).

From the user's perspective, when the alarm is silent he may want to test it. Only one control (pushbutton switch) is visible, so he presses this. The alarm goes into “test”. The user's reaction would typically be to release the pushbutton either instantaneously (before the alarm goes into “test”) or after hearing it going into “test”. The “test” cycle would last long enough to ensure it is audible to the user in either case.

If the alarm is in “full alarm” mode, the user may want to silence it. Again, only one control is visible so he presses this. The alarm goes into “silence” mode.

The alarm includes a single button which is configured to scroll through the various functions of the alarm when the button is activated in a particular fashion.

With this configuration when the button is activated there will be a reaction to the prevailing condition and there is no need for any detailed analysis. Further if the alarm is in a non-reacting mode, and therefore silent the pressing of the button will activate the test circuits of the alarm/detector.

This solution does not preclude the initiation of multiple functions by other means in addition to a single control button. For example, an alarm connected to an electric lighting circuit could be controlled by counting the number of times that the light switch is flicked in a short time.

FIG. 5 shows a circuit diagram 70 for the preferred embodiment of alarm which provides the above described single switch function. The circuit has a microprocessor 72 which controls operation of the alarm in dependence on the sensed input from the smoke/pollutant detector 74. A switch SW1 is connected in a line between the collector-emitter junction of two series connected transistors Q1b, Q1a and a terminal of the microprocessor, and is actioned by pressing the button 5 on the alarm housing. When switch SW1 is pushed (closed) and the alarm is off the emitter of Q1b is taken towards ground and the transistor Q1b is switched on, as is Q2, and the detector 74 is pulled low into an alarm state.

When the alarm is on and SW1 is pushed, Q1a is switched on which triggers the silence function on pin1 of microprocessor 72.

What is claimed is:

1. An alarm for detecting radiation and/or pollutants such as smoke, carbon monoxide or the like comprising:
a housing;
a mounting assembly configured to mount the housing to a flat surface;
cooperating assemblies on the housing and on the mounting assembly, the cooperating assemblies being mutually engageable to secure the housing to the mounting assembly;
an alarm circuit including a detector for detecting the radiation and/or pollutants, and
a controller configured to control an arming of the alarm circuit, the controller comprising a switch assembly;
wherein the cooperating assemblies actuate the switch assembly upon engagement of the housing with the mounting assembly to thereby cause the controller to arm the alarm circuit.

2. An alarm as claimed in claim 1, wherein the switch assembly comprises a magnetically operated switch and the cooperating assemblies comprise a magnet assembly.

3. An alarm as claimed in claim 2, wherein the magnet assembly includes a permanent magnet.

4. An alarm as claimed in claim 1, wherein the switch assembly is configured to control a supply of power to the alarm circuit.

5. An alarm as claimed in claim 1, wherein the switch assembly includes a normally open switch in a power supply line for the alarm circuit.

6. An alarm for detecting radiation and/or pollutants such as smoke, carbon monoxide or the like, comprising:
a housing;
a mounting assembly configured to mount the housing to a flat surface;
cooperating assemblies on the housing and on the mounting assembly, the cooperating assemblies being mutually engageable to secure the housing to the mounting assembly;
a locator configured to house a battery for the alarm, and
a stop assembly configured to prevent proper engagement of the cooperating assemblies in the absence of the battery in the battery housing.

7. An alarm as claimed in claim 6, wherein the stop assembly is configured to be biased towards a first, stop position that prevents proper mutual engagement of the cooperating assemblies in the absence of the battery in the locator and is further configured to be displaced into a second, release position by correct insertion of the battery in the locator to thereby enable proper mutual engagement of the cooperating assemblies to secure the housing to the mounting assembly.

8. An alarm as claimed in claim 7, wherein the cooperating assemblies are mutually engageable by rotation of the housing relative to the mounting assembly to secure the housing to the mounting assembly.

9. An alarm as claimed in claim 8, wherein the cooperating assemblies comprise a retaining assembly on one of the housing and the mounting assembly and an engagement assembly on the other one of the housing and the mounting assembly.

10. An alarm as claimed in claim 9, wherein the retaining assembly comprises at least one hook-like member and the engagement assembly comprises a respective flange engageable under the hook-like member by rotation of the housing relative to the mounting assembly.

11. An alarm as claimed in claim 9, comprising a plurality of the cooperating assemblies that are angularly spaced about an axis of rotation of the housing and the mounting assembly.

12. An alarm as claimed in claim 9, wherein the retaining assembly is provided on the housing and the engagement assembly is provided on the mounting assembly.

13. An alarm as claimed in claim 8, wherein:
the locator comprises a battery compartment;
the stop assembly comprises:
a battery sensing member on the mounting assembly extending over the battery compartment and downwardly towards the housing, and
an abutment on the housing;
wherein
in the absence of a battery in the battery compartment, the battery sensing member abuts the stop on relative rotation of the housing relative to the mounting assembly to prevent proper engagement of the cooperating assemblies;
and in the presence of a correctly inserted battery in the battery compartment, the battery sensing member is biased away from the housing so as to clear the stop on relative rotation of the housing relative to the mounting assembly and allow proper engagement of the cooperating assemblies.

14. An alarm as claimed in claim 13, wherein the battery sensing member includes a tongue-like member.

15. An alarm as claimed in claim 13, comprising:
an additional abutment engageable with the battery sensing member on relative rotation of the housing and the mounting assembly to prevent proper engagement of the cooperating assemblies when the mounting assembly and the housing are incorrectly aligned.

16. An alarm as claimed in claim 15, wherein at least one of the abutment and the additional abutment comprises an end wall of a recess in the surface of the housing.

17. An alarm as claimed in claim 14, wherein the recess has a ramp-like base.

18. An alarm as claimed in claim 6, wherein the locator comprises a battery compartment that is configured to prevent incorrect insertion of the battery into the compartment.

19. An alarm as claimed in claim 18, wherein:
the battery is of a type having positive and negative terminals of different sizes at one end;
the battery compartment includes electrical contacts at one end thereof for connection to the terminals of the battery, and
the battery compartment is configured, on the end wall, to prevent insertion of the battery with the terminals transposed.

20. An alarm as claimed in claim 19, wherein the battery compartment is further configured to define a recess in the end wall for receiving a smaller one of the positive and negative battery terminals, the defined recess being too small to receive a larger one of the positive and negative battery terminals.

21. An alarm for detecting radiation and/or pollutants such as smoke, carbon monoxide or the like, comprising:
a housing;
mounting assembly for mounting the housing to a flat surface;
cooperating assemblies on the housing and on the mounting assembly, the cooperating assemblies being mutually engageable to secure the housing to the mounting assembly, and
an alarm circuit including a detector configured to detect the radiation and/or pollutants,
wherein:
the mounting assembly comprises a generally planar mounting plate having an upper surface and a through-opening for receiving a fixing such as a screw for fixing the mounting assembly to a generally flat surface, the through-opening being elongate and having an enlarged portion for passage of a head of the fixing through the through-opening, a narrowed portion for retention of the head and a neck portion therebetween.

22. An alarm as claimed in claim 21, wherein the neck portion defines a wall portion, the wall portion being formed by a tongue, the tongue being adapted to resile away from the opposing wall of the neck portion thereby to allow passage of the fixing from the enlarged portion to the narrowed portion, and to prevent passage of the fixing from the narrowed portion to the enlarged portion.

23. An alarm for detecting radiation and/or pollutants such as smoke, carbon monoxide or the like, comprising:
a housing;
mounting assembly for mounting the housing to a flat surface;
cooperating assemblies on the housing and on the mounting assembly, the cooperating assemblies being mutually engageable to secure the housing to the mounting assembly, and
an alarm circuit, the alarm circuit including a detector configured to detect the radiation and/or pollutants,
wherein the alarm circuit includes an actuation assembly that is configured to scroll through various functions of the alarm when the actuation assembly is activated in a predetermined fashion.

24. An alarm as claimed in claim 23, wherein the alarm circuit comprises a microprocessor configured to control an operation of the alarm, wherein the actuation assembly comprises a switch in the alarm circuit, and wherein the alarm circuit is configured such that when the alarm is activated, actuation of the switch silences the alarm and configured such that, when the alarm is silent, actuation of the switch tests the alarm.
